(19) United States
(12) Patent Application Publication
(10) Pub. No.: US 2002/0194405 A1
(43) Pub. Date: Dec. 19, 2002

(54) Disk array system with large storage capacity

(76) Inventor: Su-Syang Huang, Hsinchu (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/160,860

(22) Filed: May 31, 2002

(30) Foreign Application Priority Data
Jun. 15, 2001 (TW) 90210132

(51) Int. Cl. G06F 13/12

(52) U.S. Cl. 710/74; 710/5

(57) ABSTRACT

A disk array system comprises a host computer, a plurality of parallel I/O interface disk drives on backplane, for example, ATA or SCSI disk drives, and a disk array controller. The disk array controller includes a local PCI bus and serial I/O interface controllers for coupling the parallel I/O disk drives to the host computer. The disk array controller is operatively configured to control the parallel I/O interface disk drives by the serial I/O interface controllers. The serial I/O interface controllers act as bus masters with respect to the local PCI bus, and access the parallel I/O disk drives through the local PCI bus read/write cycle operation. By way of controlling the parallel I/O interface disk drives through serial I/O interface controllers, the limitation on the effective transmission length inherently in the parallel I/O interface cable is loosened and the disk array controller is capable of controlling more disk drives.

### FIELD OF THE INVENTION

The present invention is generally in association with a disk array system, and more particularly, the present invention is in association with a hardware-implemented disk array system (also known as a RAID system) with a large storage capacity.

### DESCRIPTION OF THE PRIOR ART

As known in the art, disk array system is also referred to as a computer data storage system, in which data is distributed or stripped across multiple disk drives. Data is stored in the disk array system based on several mathematical algorithms, such that the data lost as a result of a single disk drive failure can be automatically reconstructed.

The conventional disk array system for personal computer (PC), workstation or server is illustrated in FIG. 1 and FIG. 2. References are now made to FIG. 1. The disk array system includes a disk array controller 11, typically an external disk array control card, for coupling the parallel I/O interface disk drives 121-128 on the backplane 12, such as ATA (AT attachment) disk drives or SCSI (small computer systems interface) disk drives, to the host computer 10. The disk array controller 11 is coupled to the host computer 10 through a host interface 105, such as a SCSI bus, an ATA bus, a S-ATA bus, a fibre channel interface or an infiniband bus. The host CPU 101 and the system memory 102 of the host computer 10 communicate with the disk array controller 11 via the host PCI (peripheral component interconnect) bus 103. The I/O controller 104 of the host computer 10 is directed to a PCI device that is plugged into on the PCI expansion slot of the host computer 10 (for simplicity, the PCI expansion slot is not shown in the drawings), and it translates the data of the host PCI bus 103 into the data of the host interface 105. The disk array controller 11 further includes an I/O controller 115 which translates the data of the host interface 105 into the data of the local PCI bus 114. Four or more parallel I/O interface controllers 116-119 are coupled to the local PCI bus 114 of the disk array controller 11. Each of the parallel I/O interface controllers 116-119 is assigned to control the operations of two of the parallel I/O interface disk drives 121-128 on the backplane 12 via the parallel I/O interface 15. The disk array controller 11 further includes a microcontroller 111 and a memory device (which functions as a buffer) 112 that are coupled to the local PCI bus 114 of the disk array controller 11 through appropriate bridge circuits (not shown).

FIG. 2 shows a schematic block diagram of another type of prevalent prior art disk array system. In comparison with the conventional disk array system of FIG. 1, the disk array controller 11 of FIG. 2 is substantially a PCI device with respect to the host computer 10. As shown in FIG. 2, a disk array controller 11, which is generally designated to as a RAID control card, is plugged into the PCI expansion slot of the host computer 10 and communicates with the host CPU 101 and the system memory 102 of the host computer 10 through the host PCI bus 103. The disk array controller 11 further comprises a PCI-to-PCI bridge 113 which couples the host PCI bus 103 of the host computer 10 to the local PCI bus 114 of the disk array controller 11 and acts as a bus mater with respect to both the host PCI bus 103 and the local PCI bus 114. Four or more parallel I/O interface controllers 116-119 are coupled to the local PCI bus 114 of the disk array controller 11. Each of the parallel I/O interface controllers 116-119 is assigned to control the operations of two of the parallel I/O interface disk drives 121-128 on the backplane 12 via the parallel I/O interface 15. The disk array controller 11 further includes a microcontroller 111 and a memory device (which functions as a data buffer) 112 that are coupled to the local PCI bus 114 of the disk array controller 11 through appropriate bridge circuits (not shown).

Even so, as can be known by anyone skilled in the related art, the most common communication interface for enabling the disk drive to communicate with other system buses, control chipsets and peripherals is involved in an ATA bus interface or a SCSI bus interface, both of which act as a parallel I/O interface. When data and control signals are intended to transmit onto the ATA interface, a 45 centimeters limitation on the effective transmission length will be imposed on the parallel I/O interface cable owing to the attenuation of signal intensity. Consequently, if the parallel I/O interface 15 is introduced to the disk array system to be the communication interface for enabling the disk array controller 11 to control the operations of the parallel I/O interface disk drives 121-128, the manageable disk drives of the disk array controller 11 will be restricted on account of the inherent effective transmission length limitation on the parallel I/O interface cable. Further, the number of parallel I/O interface disk drives that the disk array system can support will be limited to a certain extent.

It would be highly desirable to develop a disk array system which has the faculty of loosening the limitations resulting from the effective transmission cable length of the parallel I/O interface as signals are transmitted thereon, so that the disk array controller is capable of controlling more disk drives and then enlarging the storage capacity of the whole disk array system.

### SUMMARY OF THE INVENTION

A first object of the present invention is to provide a disk array controller which employs a serial I/O interface controller to communicate with disk drives, in such a way that the disk array controller can control more disk drives.

A second object of the present invention is to provide a disk array system with large storage capacity, in which the disk array controller employs serial I/O interface that is more adapted to transmit signals with longer transmission cable than the parallel I/O interface to control the disk drives, whereby enlarging the storage capacity of the disk array system.

In accordance with a first aspect of the present invention, a disk array controller which couples a host computer having a host processor and a system memory to an array of disk drives comprises a local PCI bus, a serial I/O interface controller coupled between the local PCI bus and the array of disk drives is operatively connected to and configured to control the operation of at least one disk drive of the array, a memory device, more preferably a buffer memory, for storing an I/O data transferred among the system memory and the disk drives, and a microcontroller which dispatches control commands and data in response to the I/O request generated by the host computer to the serial I/O interface controller to initialize a transfer of the I/O data among the host computer and the disk drives.

On basis of a first preferred configuration of the disk array controller as well as the host computer, the host computer as described hereinbefore may be made up by a personal computer, a workstation or a server, and is coupled with the disk array controller by a host interface, for example, a SCSI bus, an ATA bus, a S-ATA bus, a fibre channel bus or an infiniband bus. The disk drives are directed to parallel I/O interface disk drives, such as ATA or SCSI disk drives. In addition, the host computer further includes a first I/O controller which translates the data of the host PCI bus of the host computer into the data of the host interface, and the disk array controller also includes a second I/O controller which translates the data of the host interface into the data of the local PCI bus.

On basis of a second preferred configuration of the disk array controller as well as the host computer, the disk array controller is looked upon for a system bus master device which communicates with the host computer by a system bus of the host computer. Generally speaking, the above-mentioned system bus is directed to a host PCI bus. As a result, the disk array controller of the present invention can be carried out by a PCI device comprising a bridge circuit for coupling the host PCI bus to the local PCI bus.

To attain the objectives of utilizing serial I/O interface to control the operations of the parallel I/O interface disk drives, a serial-to-parallel converter is required to be located between one of the parallel I/O interface disk drives and the serial I/O interface for coupling the disk drive to the serial I/O interface. More preferably, the serial I/O interface controller can be conducted to a USB controller, an IEEE1394 controller or a fibre channel interface controller, which controls the operation of at least one disk drive of the array through a USB interface, an IEEE1394 bus interface or a fibre channel interface.

The present invention also provides a disk array system, comprising a host computer, an array of disk drives, and a disk array controller comprising a local PCI bus for coupling the host computer to the array of disk drives, and including a serial I/O interface controller coupled to the local PCI bus for receiving a control command and data contained in an I/O request generated by the host computer to control at least one disk drive of the array.

According to a first preferred embodiment of the present invention, the host computer is directed to either a personal computer, a workstation or a server, and is coupled to the disk array controller by a host interface, for example, a SCSI bus, an ATA bus, a S-ATA bus, a fibre channel interface or an infiniband bus. On the other hand, however, according to an alternative configuration of the disk array system in a second preferred embodiment of the present invention, the disk array controller may be coupled to the host computer via a system bus of the host computer, such as a host PCI bus, and serves as a system bus master device.

For the purpose of utilizing serial I/O interface to control the operations of the parallel I/O interface disk drives, a serial-to-parallel converter is required to be located between one of the parallel I/O interface disk drives and the serial I/O interface for coupling the parallel I/O interface disk drive to the serial I/O interface. More preferably, the serial I/O interface controller can be conducted to a USB controller, an IEEE1394 controller or a fibre channel interface controller, which controls the operation of at least one disk drive of the array through a USB interface, an IEEE1394 bus interface or a fibre channel interface.

Now the foregoing and other features and advantages of the present invention will be best understood through the following descriptions with reference to the drawings presented herein, in which:

### BRIEF DESCRIPTION OF THE DRAWINGS

FIG. 1 schematically depicts a circuit block diagram of prior art disk array system, in which the disk array controller is coupled to the host computer by a host interface;

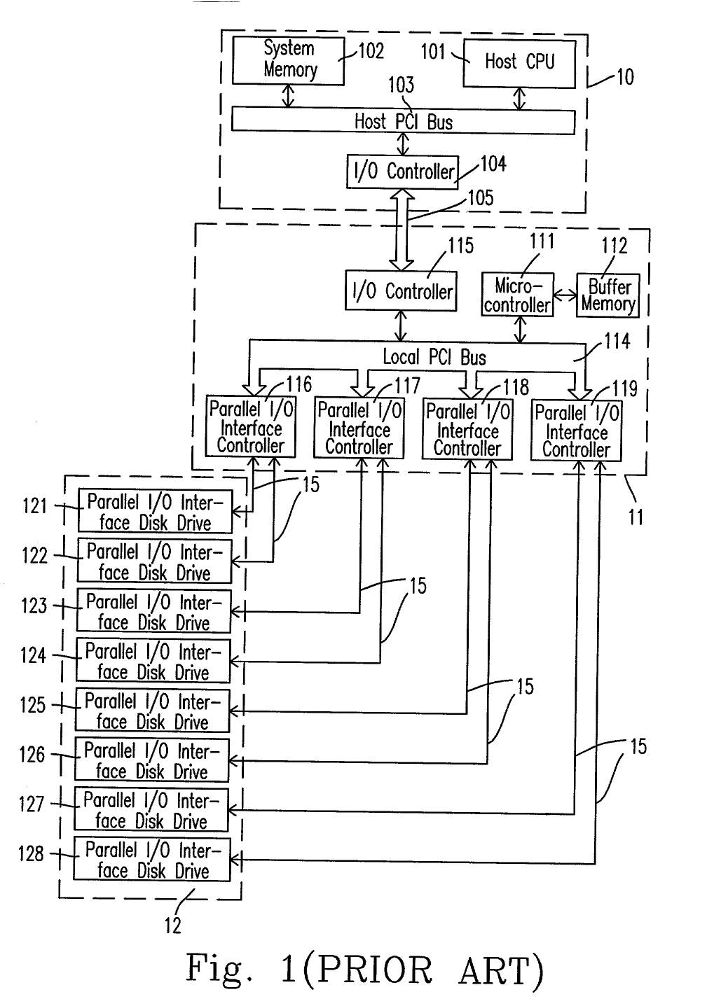

FIG. 2 schematically depicts a circuit block diagram of prior art disk array system, in which the disk array controller is a PCI device with respect to the host computer;

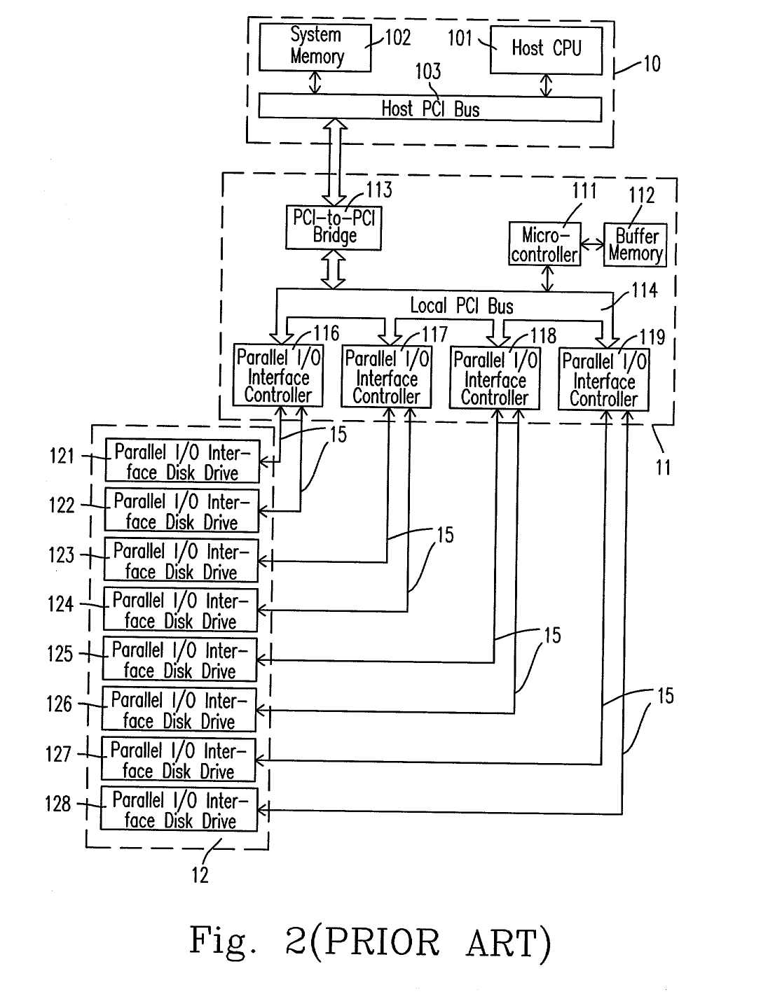

FIG. 3 is a functional block diagram showing a first preferred embodiment of the disk array system according to the present invention, in which the disk array controller is coupled to the host computer by a host interface;

FIG. 4 is a functional block diagram showing a second preferred embodiment of the disk array system according to the present invention, in which the disk array controller is a PCI device with respect to the host computer;

FIG. 5 is a functional block diagram illustrating the configuration of the disk array system of FIG. 3, in which the serial I/O interface controller is designated to as an IEEE1394 controller and the parallel I/O interface disk drive is designated to as an ATA disk drive; and

FIG. 6 is a functional block diagram illustrating the configuration of the disk array system of FIG. 4, in which the serial I/O interface controller is designated to as an IEEE1394 controller and the parallel I/O interface disk drive is designated to as an ATA disk drive.

### DETAILED DESCRIPTION OF THE PREFERRED EMBODIMENT

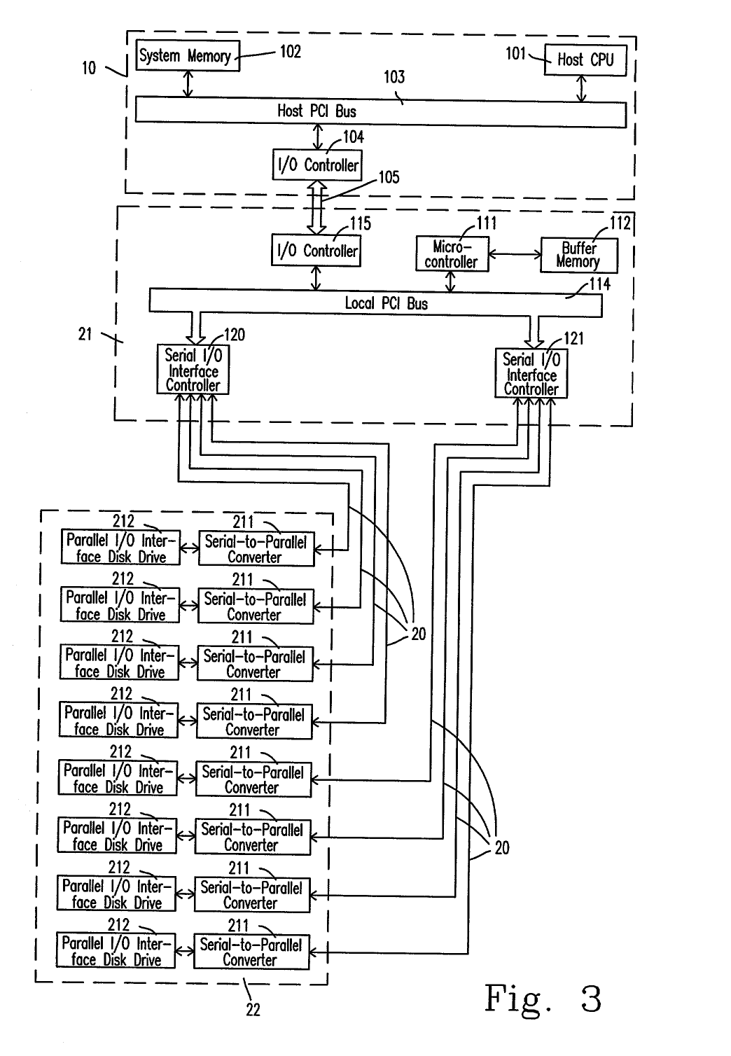

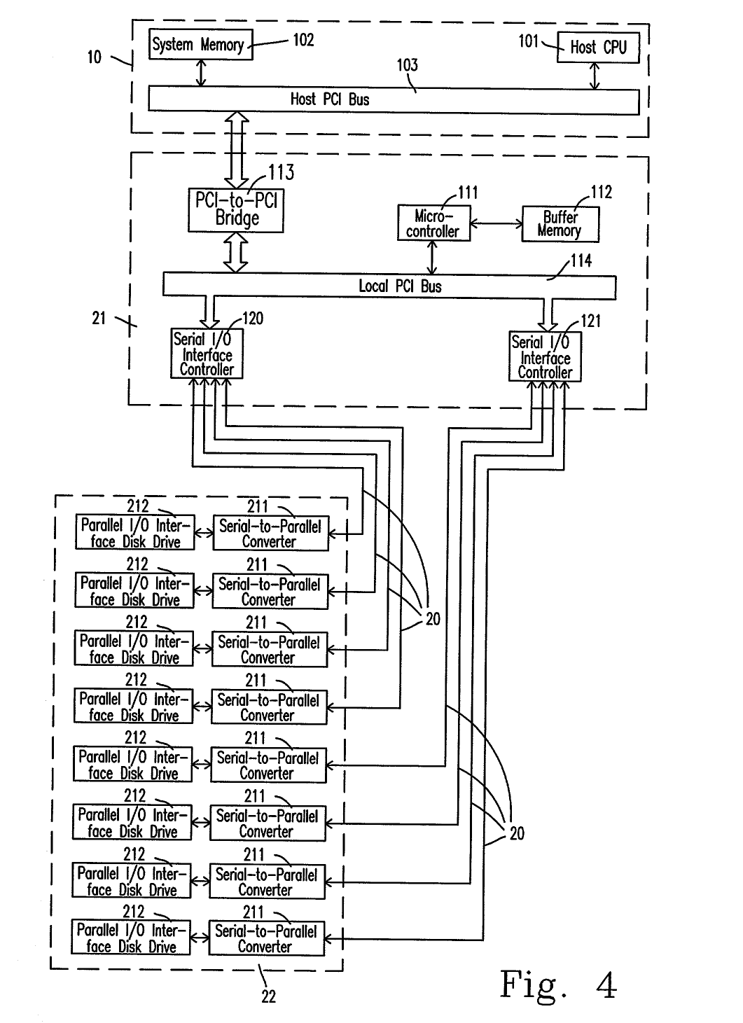

The exemplary embodiments of the present invention will now be described in detail with reference to the following preferred embodiments. FIG. 3 shows a functional block diagram of the disk array system in accordance with a first preferred embodiment of the present invention, in which the disk array controller 21 is coupled to the host computer 10 by a host interface 105. FIG. 4 shows a functional block diagram of the disk array system in accordance with a second preferred embodiment of the present invention, in which the disk array controller 21 is a PCI device with respect to the host computer 10. It should be noted that the drawings accompanying with the present invention will indicate the identical component with the selfsame reference numeral. The disk array system of the present invention comprises a host computer 10, for example, a personal computer, a workstation or a server, a disk array controller 21 and a backplane 22 with eights parallel I/O interface disk drives deposited therein. As discussed above, the prior art disk array system utilizes parallel I/O interface such as ATA bus or SCSI bus as the communication interface for the disk array controller to control the disk drives connected therewith, the disk array controller can not augment the number of the manageable disk drives due to the effective transmission length limitation on the parallel I/O interface cable. With the intention of loosening the restriction of effective transmission length on the parallel I/O interface cable and the resulted manageable disk drives prescription, the disk array system of the present invention employs a serial I/O interface 20, for instance, a USB interface, an IEEE1394 bus interface or a fibre channel interface, as the interface for enabling the disk array controller 21 to control the operations of the parallel I/O interface disk drives 212 on the backplane 22.

As indicated in FIG. 3 and FIG. 4, the disk array controller 21 in the disk array system of the present invention comprises two serial I/O interface controllers 120 and 121, which serve as a disk control unit for controlling the parallel I/O interface disk drives 212 on the backplane 22. Each of the serial I/O interface controllers 120 and 121 is operatively configured to control four of the parallel I/O interface disk drives 212. Nonetheless, because the parallel I/O interface disk drives 212 on the backplane 22 utilize parallel I/O interface as the interface for getting into communication with other hardware components, a plurality of serial-to-parallel converters 211 is required to be located within the backplane 22, and each of the serial-to-parallel converters 211 is used to convert the signals transmitted onto the serial I/O interface 20 into the format that can be transmitted onto the parallel I/O interface. It is noticeable that the attenuation of the signal intensity taken place in the serial I/O interface is much less than the parallel I/O interface, the serial I/O interface is by far the most suitable interface to transmit signals with a long transmission cable. If the serial I/O interface 20 is arranged to be the communication interface among the disk array controller 21 and the parallel I/O disk drives 212, the accessible disk drives of the disk array controller will be much increased because the interface that is adapted to transmit signals with a longer transmission cable is provided for the disk array controller to control the disk drives. Such disk array system configuration will significantly increase the number of disk drives that the disk array system can support and thereby increase the overall storage capacity.

In operation, the host CPU 101 sends out an I/O request through the host PCI bus 103, the local PCI bus 114, and the I/O controller 104 and 105 (if the disk array controller has the configuration as shown in FIG. 3) or the PCI-to-PCI bridge 113 (if the disk array controller has the configuration as shown in FIG. 4). Typically, each of the I/O request includes a command descriptor block (CDB), which represents the specific command for parallel I/O disk drives that specify the parameters as the disk operation to be performed (such as read or write). The microcontroller 111 runs a firmware program in response to the I/O request generated by the host computer 10 to translate the I/O requests into component, disk-specific parallel I/O disk drive commands based on a particular RAID configuration (such as RAID 3 or RAID 5), and dispatch the commands to corresponding serial I/O interface controllers 120 and 121 via the local PCI bus 114 to initialize the I/O data transfer procedure among the disk drives 212 and the host computer 10. The serial I/O controllers 120 and 121 serve as bus masters of the local PCI bus 114 and thus have the capability of accessing the registers of the peripherals connected to the local PCI bus 114. With regard to the operation of accessing the parallel I/O disk drives 212 by the serial I/O interface controllers 120 and 121, it begins as the serial I/O interface controllers 120 and 121 obtain the bus mastership of the local PCI bus 114 from the bus arbiter of the local PCI bus 114 (now shown), and then access the parallel I/O disk drives 212 in accordance with the read/write bus cycle operation of the local PCI bus 114. The I/O data transfer among the system memory 102 and the parallel I/O disk drives 212 can be effectively carried out in virtue of accessing the parallel I/O disk drives by the serial I/O interface controllers 121 and 121. At the beginning, the data transferred from the system memory 102 is stored in the buffer memory 112. The buffer memory 112 also executes rebuild operations in response to disk failures and other operations in connection with the particular RAID configuration. The microcontroller 111 will persistently monitor the processing of the dispatched parallel I/O disk drive commands and interrupt the host CPU 101 to notify the host computer 10 of the completed I/O data transfer operation.

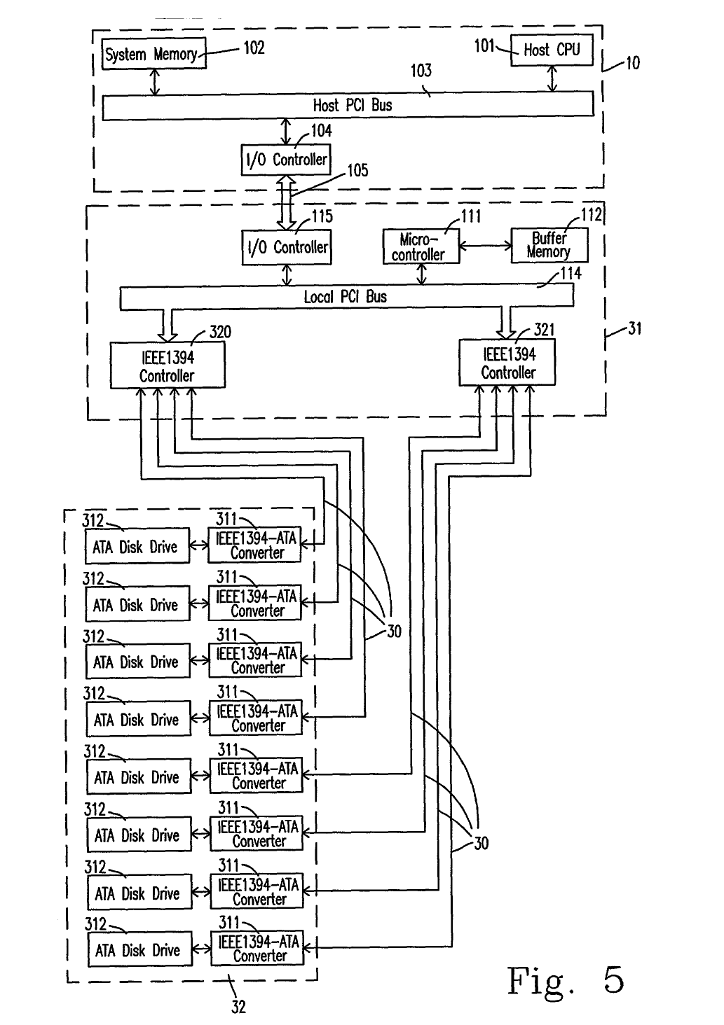

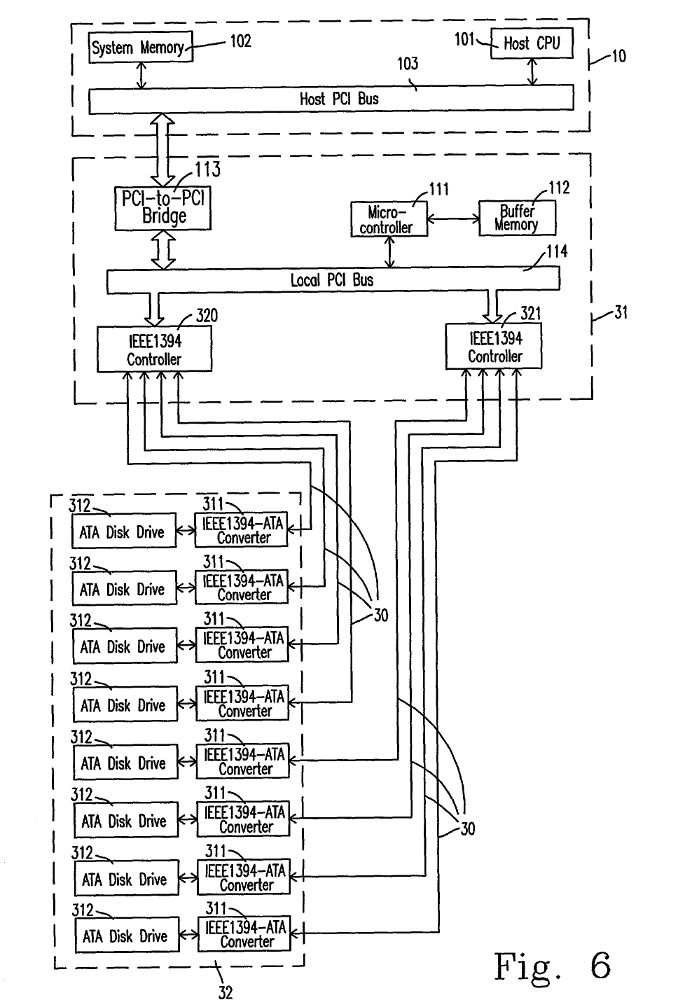

FIG. 5 and FIG. 6 respectively demonstrates a functional block diagram of a preferred embodiment of the disk array system according to the present invention, in which the serial I/O interface controller is designated to as IEEE 1394 controllers 320 and 321, and the disk array controller is operatively configured to control the parallel I/O disk drives 312 on the backplane 32 via IEEE1394 bus interface 30. As already known by the art in connection with serial interface communication technique, IEEE1394 bus interface is a bus interface with large data transfer throughput, and is capable of providing up to 62 peripherals to proceed to data transfers with other peripherals. Hence, the disk control unit in the disk array controller 31 of the disk array system according to the present invention can be accomplished by IEEE1394 controllers 320 and 321, and in this way, the disk array controller 31 can control the parallel I/O disk drives 312 on the backplane 32 via IEEE 1394 bus interface 30. It is readily known that the parallel I/O interface disk drives of FIG. 5 and FIG. 6 are embodied in ATA disk drives 312. In order to enable the IEEE1394 controllers 320 and 321 to have the capability of accessing the ATA disk drives 312, IEEE1394-ATA converters 311 each of which is located between the IEEE1394 bus interface 30 and an ATA disk drive 312 must be provided within the backplane 32 for converting the signals transmitted onto the IEEE1394 bus interface 30 into the signals that is adapted to be transmitted onto the ATA bus interface. As mentioned above, the IEEE1394 bus interface is capable of providing up to 62 peripherals to proceed to data transfers with other peripherals. In this manner, the disk array controller 31 is subjected to control the operation of the ATA disk drives 312 on the backplane 32 in virtue of the IEEE1394 bus interface 30. Above all, the number of the accessible disk drives of the disk array controller can be maximized, and the performance of the disk array system can be optimized.

In summary, the disk array system of the present invention is highlighted by employing serial I/O interface controllers to implement the function of disk operation control for the disk array controller. Because the parallel I/O interface cable is unavoidably confronted with the inherent effective transmission length limitation, the art of taking the serial I/O interface, such as USB interface, IEEE1394 interface or fibre channel interface that is provided with a much longer effective transmission length, as the control interface for the disk array controller to access the parallel I/O interface disk drives is able to address the deficiency encountered by the parallel I/O interface. The disk array system that makes use of serial I/O interface as the communication interface among the disk array controller and the disk drives will unquestionably lead to an increasing number of manageable disk drives and an enlarged disk storage capacity, and further the steadiness and reliably of the signal transmission can be enhanced.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A disk array controller which couples a host computer having a system memory to an array of disk drives, comprising:
a first bus;
a serial I/O interface controller coupled between said first bus and said array of disk disks, which is operatively connected to and configured to control at least one disk drive of said array through a serial I/O interface;
a memory device for storing an I/O data transferred among said system memory and said disk drives; and
a microcontroller which dispatches control commands and data in response to the I/O request generated by said host computer to said serial I/O interface controller to initialize a transfer of the I/O data among said host computer and said disk drives.

2. The disk array controller of claim 1, wherein said host computer comprises one selected from a personal computer, a workstation and a server.

3. The disk array controller of claim 1, wherein said disk array controller is coupled to said host computer by a host interface.

4. The disk array controller of claim 3, wherein said host interface comprises one selected from a SCSI bus, an ATA bus, a S-ATA bus, a fibre channel interface, and an infiniband bus.

5. The disk array controller of claim 3, wherein said host computer further comprises a first I/O controller for translating data of a system bus of said host computer into data of said host interface, and said disk array controller further comprises a second I/O controller for translating data of said host interface into data of said first bus.

6. The disk array controller of claim 5, wherein said first bus is a local peripheral component interconnect (PCI) bus, and said system bus of said host computer is a host PCI bus.

7. The disk array controller of claim 1, wherein said disk drives comprise parallel I/O interface disk drives.

8. The disk array controller of claim 7, wherein said parallel I/O interface comprises one selected from an ATA (AT attachment) bus and a SCSI (small computer systems interface) bus.

9. The disk array controller of claim 1, wherein said disk array controller is coupled to said host computer by a system bus of said host computer.

10. The disk array controller of claim 9, further comprising a bridge circuit for coupling said system bus of said host computer to said first bus.

11. The disk array controller of claim 10, wherein said first bus is a local PCI bus, and said system bus of said host computer is a host PCI bus.

12. The disk array controller of claim 1, wherein said array of disk drives is deposited on a backplane, said backplane is provided with serial-to-parallel interface converters, and each of said serial-to-parallel interface converters is coupled between one of said disk drives and said serial I/O interface.

13. The disk array controller of claim 1, wherein said serial I/O interface controller is a USB controller, and said serial I/O interface is a USB interface.

14. The disk array controller of claim 1, wherein said serial I/O interface controller is an IEEE1394 controller, and said serial I/O interface is an IEEE1394 bus interface.

15. The disk array controller of claim 1, wherein said serial I/O interface controller is a fibre channel controller, and said serial I/O interface is a fibre channel interface.

16. A disk array system comprising:
a host computer;
an array of disk drives; and
a disk array controller including a first bus for coupling said array of disk drives to said host computer, and including a serial I/O interface controller coupled to said first bus for receiving a control command and data contained in an I/O request generated by said host computer, to control at least one disk drive of said array through a serial I/O interface.

17. The disk array system of claim 16, wherein said host computer comprises one selected from a personal computer, a workstation and a server.

18. The disk array system of claim 16, wherein said disk array controller is coupled to said host computer by a host interface.

19. The disk array system of claim 18, wherein said host interface comprises one selected from a SCSI bus, an ATA bus, a S-ATA bus, a fibre channel interface, and an infiniband bus.

20. The disk array system of claim 18, wherein said host computer further comprises a first I/O controller for translating data of a system bus of said host computer into data of said host interface, and said disk array controller further comprises a second I/O controller for translating data of said host interface into data of said first bus.

21. The disk array system of claim 20, wherein said first bus is a local peripheral component interconnect (PCI) bus, and said system bus of said host computer is a host PCI bus.

22. The disk array system of claim 16, wherein said disk drives comprise parallel I/O interface disk drives.

23. The disk array system of claim 22, wherein said parallel I/O interface comprises one selected from an ATA (AT attachment) bus and a SCSI (small computer systems interface) bus.

24. The disk array system of claim 16, wherein said disk array controller is coupled to said host computer by a system bus of said host computer.

25. The disk array system of claim 24, wherein said disk array controller further comprises a bridge circuit for coupling said system bus of said host computer to said first bus.

26. The disk array system of claim 24, wherein said first bus is a local peripheral component interconnect (PCI) bus, and said system bus of said host computer is a host PCI bus.

27. The disk array system of claim 16, further comprising a backplane for receiving said array of disk drives.

28. The disk array system of claim 27, wherein said backplane is provided with serial-to-parallel interface converters, and each of said serial-to-parallel interface converters is coupled between one of said disk drives and said serial I/O interface.

29. The disk array system of claim 16, wherein said serial I/O interface controller is a USB controller, and said serial I/O interface is a USB interface.

30. The disk array system of claim 16, wherein said serial I/O interface controller is an IEEE1394 controller, and said serial I/O interface is an IEEE1394 bus interface.

31. The disk array system of claim 16, wherein said serial I/O interface controller is a fibre channel controller, and said serial I/O interface is a fibre channel interface.
